(19) United States
(12) Patent Application Publication
(10) Pub. No.: US 2007/0283590 A1
(43) Pub. Date: Dec. 13, 2007

(54) Systems and methods for wireless collection and transmission of measurements

(76) Inventors: Stewart B. White, Memphis, TN (US); Bruce G. Lindow, Germantown, TN (US); Chris Naugle, Hernando, MS (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/451,922

(22) Filed: Jun. 13, 2006

(51) Int. Cl. G01B 3/10

(52) U.S. Cl. 33/763

(57) ABSTRACT

Disclosed methods and systems feature a portable device for wirelessly receiving a measurement of an object and transmitting the measurement and an object identifier. The device includes two communication modules and a memory. The first communication module receives a first wireless signal that corresponds to the measurement of the object. The memory stores the measurement derived from the first wireless signal in association with the object identifier. The second communication module transmits a second wireless signal that corresponds to the measurement and the objection identifier.

### BACKGROUND

Drivers/couriers, contracted or employed by freight carriers, pick up and/or deliver freight at various customer locations. These couriers typically carry a data collection device, which may be a handheld digital device used to collect information relating to the freight. Intermec manufactures at least one such device used by couriers. The freight information collected may include a tracking number, an origination address, a destination address, relevant phone numbers, billing information, etc. After picking up freight from a customer location, the freight is often transported to a regional/central freight-sorting hub of the carrier, where the freight from the various couriers is sorted and consolidated for placement in containers or truck trailers used for the long haul delivery leg of the freight shipment.

Capacity utilization software has been developed to plan and organize freight shipment. This software may use, for example, available freight information to determine how many containers or trailers are required to carry the freight going to a particular destination. The software may suggest, for another example, a particular arrangement of freight within a container to maximize packing efficiency. This software is often used at the carrier's hub locations where the freight is consolidated in containers or trailers. The American Customer Center Operations System (ACCOPS) is an example of a system that does outbound planning for less-than-truckload freight.

In the freight industry, it is not customary for freight couriers to provide accurate freight dimensions, for most of the collected freight, to a freight distribution hub before the couriers deliver the freight to the hub. This is often due to the time constraints imposed on couriers. When drivers pick up freight or packages, the time pressure and the inconvenience of taking and entering freight measurements may cause the drivers to enter inaccurate freight dimensions, which may be simple estimates of the freight dimensions, or not to enter the dimensions at all. Consequently, freight measurements typically only become available after a driver has delivered the freight to a central distribution point or hub. In a few circumstances, when a very large load is picked up by a courier, the courier may notify a hub location to expect a large load and possibly estimate the dimensions of the large load.

When a driver provides freight dimensions, such as with a large freight item, to a capacity utilization system before bringing the freight to the hub, inaccurate dimensions may be provided due to driver estimations, which may cause inefficient load planning. More generally, because it is not customary in the freight industry to provide freight measurements in advance of delivery of freight to a hub, the arrangement of freight within containers is loaded or planned based only on the freight currently at the hub. This loading scenario can lead to inefficient loading, which may require more containers or long haul freight drivers to be utilized than necessary. This may increase the cost to the freight carrier and consequently to its customers.

There are various ways of measuring freight or objects. A common way of doing so is by using a tape measure. With a basic tape measure, after extending a tape measure along a side of an object, a user may view the tape to determine the measurement of the side. Some tape measures, such as the DigiTape® electronic tape measures manufactured by the L. S. Starrett Co, provide a small digital display of measurements that correspond to the distance that the tape is extended. The person measuring the object can view the digital display or the extended tape to determine the dimension that was measured. The most recent digital measurements may be stored in the electronic tape measure. The user may record the measurements on paper or type the measurements into a separate device such as a computer for storage.

Tape measures have been incorporated into a housing unit along with a keypad, such as the Tallyman accessory manufactured by Cubical. The Tallyman accessory may be directly attached to a hand held device, such as a portable computer made by Symbol Technologies, via a serial port to transfer measurements.

Other measurement devices include laser-based range finder devices, such as those available from Bosch and Leica Geosystems, which are typically used to measure distances between objects. Other distance finding devices include those commonly used for determining distances between a golfer and an object on a golf course. Many of these type laser-based measuring devices are designed to measure a distance across an open area between the measuring device and one or more reflective surfaces at the end of the open area. Some of these laser-based measuring devices are Bluetooth®-enabled; these devices can wirelessly transmit signals corresponding to measurements over a relatively short distance. Nonetheless, these devices are generally not appropriate for measuring the various dimensions of objects, such packages and freight.

### SUMMARY OF EXEMPLARY EMBODIMENTS

Methods and systems are disclosed that feature a portable device for collecting a measurement of a dimension of an object and transmitting the measurement and other information related to the object. The device includes two communication modules and a memory. The first communication module receives a first wireless signal that corresponds to a measurement of a dimension of the object. The memory stores the measurement derived from the first wireless signal in association with an object identifier. The second communication module transmits a second wireless signal that corresponds to the measurement of the object and the objection identifier. The portable device is suitable for use with a measuring tape that is capable of wirelessly transmitting a measurement corresponding to a sensor reading.

Another embodiment consistent with principles of the invention is a system for measuring a dimension of an object. The system includes a tape measure and a portable data collection device. The tape measure includes a communication module for transmitting a wireless signal that corresponds to a measurement of a dimension of the object. The portable data collection device includes a communication module and a memory. The communication module of the portable data collection device enables the receipt of the wireless signal. The device memory enables storage of the measurement derived from the wireless signal.

Another embodiment consistent with principles of the invention is a method for collecting a dimension of an object. The method includes extending a tape along a first side of a first object and generating a first variable with a sensor while the tape is extended along the first side of the first object. The first variable corresponds to a measurement of the first side of the first object. A first wireless signal is transmitted using a short-range wireless transmission protocol. The first wireless signal corresponds to the first variable. The measurement is derived from the first wireless signal and associated with an object identifier and a destination for the first object. Then, a second wireless signal is transmitted using a long-range transmission protocol. The second wireless signal corresponds to the associated measurement, identifier, and destination for the first object.

Another embodiment consistent with principles of the invention is a method for planning a loading arrangement based on measurements and destinations of a plurality of objects. The method includes extending a tape along a first side of a first object, and generating a first variable with a sensor while the tape is extended along the first side of the first object. The first variable corresponds to a measurement of the first side of the first object. A first wireless signal is transmitted using a wireless transmission protocol. The first wireless signal corresponds to the first variable. The measurement is derived from the first signal and associated with an object identifier and a destination. A second wireless signal is transmitted using a long-range transmission protocol. The second wireless signal corresponds to the associated measurement, identifier, and destination for the first object. Steps are repeated for additional objects. A load-planning algorithm uses the associated measurement, identifier, and destination for a plurality of objects to generate an outbound loading plan for an outbound vehicle.

Another embodiment consistent with principles of the invention is a method for collecting a dimension of an object. The method includes rolling a wheel along a first side of a first object and generating a first variable with a sensor based on the revolutions of the wheel. A first wireless signal is transmitted using a short-range wireless transmission protocol. The first wireless signal corresponds to the first variable. A measurement is derived from the first wireless signal and associated with an object identifier and a destination for the first object. A second wireless signal is transmitted using a long-range wireless transmission protocol. The second wireless signal corresponds to the associated measurement, identifier, and destination for the first object.

Additional embodiments consistent with principles of the invention are set forth in the detailed description which follows or may be learned by practice of methods or use of systems or articles of manufacture disclosed herein. It is understood that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1 is a block diagram of a device for measuring a dimension of an object, consistent with the present invention;

FIG. 2 is a block diagram of a system for measuring a dimension of an object, consistent with the present invention;

FIG. 3 is a block diagram of a system for generating a loading plan based on a dimension of an object, consistent with the present invention;

FIG. 4 is a flow chart of an exemplary method for measuring a dimension of an object, consistent with the present invention;

FIG. 5 is a flow chart of an exemplary method for wirelessly receiving and associating information relating to an object, consistent with the present invention;

FIG. 6 is a flow chart of an exemplary method for determining a cost of shipping an object to a destination, consistent with the present invention; and

FIG. 7 is a flow chart of an exemplary method for generating a loading plan for a plurality of objects, consistent with the present invention.

### DETAILED DESCRIPTION

Reference is now made in detail to exemplary embodiments of the invention, examples of which are illustrated in the accompanying drawings.

Methods and systems consistent with principles of the present invention relate to a portable data collection device for wirelessly receiving a measurement of a dimension or dimensions of an object, such as a package or freight, and transmitting the measurement in conjunction with other information relating to the object. The portable data collection device may receive the measurement from a measurement device with a wireless transmission module. The information from the portable data collection device can be used to generate a loading plan for a container, such as a cargo bay or trailer, before one or more objects are received at central location or hub.

A method and system consistent with an embodiment of the invention can be used within a freight transportation system for convenient load pre-configuration/planning before freight is received at a hub. By providing couriers with a convenient method of capturing, formatting, and wirelessly transmitting freight measurements in advance to a freight consolidation/distribution hub, freight carrier may develop or begin developing freight loading plans for containers ahead of the freight arrival at a hub. By doing so, unnecessary time, cost and/or inefficiencies associated with loading can be avoided.

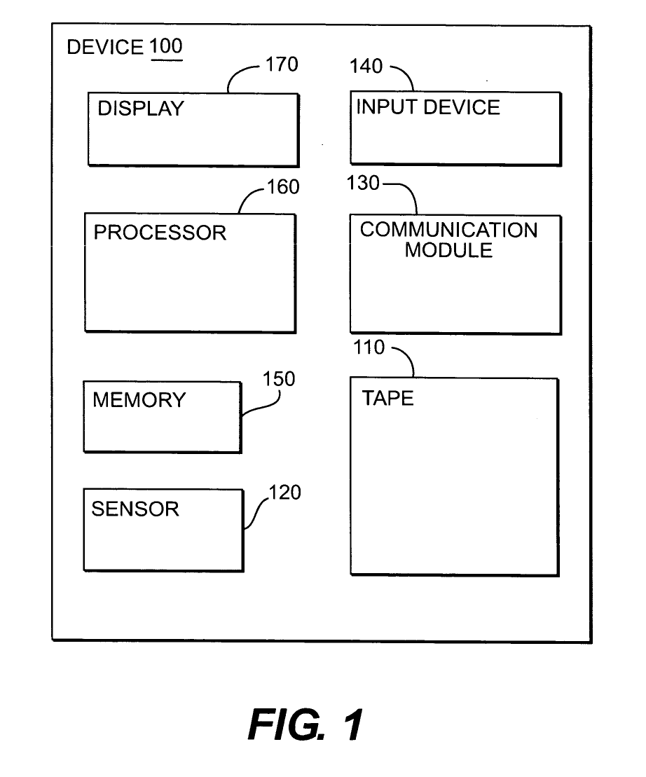

FIG. 1 is a block diagram of a device for measuring a dimension of an object in accordance with one illustrative embodiment. Device 100 may implement one or more methods consistent with features and principles of the present invention. Device 100 includes a measurement instruments such as an extendable tape 110. Device 100 also includes a sensor 120 and a communications module 130. The components of device 100 can be integrated within a housing (not shown). The dimensions and material of tape 110 make it appropriate for extending and retracting. Various types of appropriate tape materials can include, for example, metals, polymers, and fiberglass. Tape 110 can be made of any material suitable for measuring a side of an object.

Sensor 120 is coupled to tape 110. A reading of sensor 120 corresponds to a measurement of a dimension of an object. The sensor reading can be generated in several different ways. For example, when the measurement instrument is tape 110, sensor 120 generates the first signal by determining how far tape 110 has been extended. For another example, sensor 120 can read one or more of the nearest markings on tape 110. Where tape 110 includes one or more markings, each marking may be designed for use with sensor 120. These markings may be, for example, bar codes. Where tape 110 includes one or more markings, markings may also enable a user to visually confirm a measurement of an object.

It should be appreciated that device 100 could alternatively include any other instrument that is capable of providing a measurement of a dimension of an object when coupled to a sensor. For example, a roller wheel could alternatively be coupled to sensor 120. When the measurement instrument is a roller wheel coupled to sensor 120, sensor 120 determines a measurement based on the revolutions of the wheel.

Communications module 130 is capable of transmitting a wireless signal corresponding to the reading of sensor 120. Communications module 130 includes components that enable wireless transmission of a signal at an available frequency range using an appropriate protocol. In one exemplary embodiment, communications module 130 enables wireless transmission of a signal using a protocol consistent with the Bluetooth® standards. In another embodiment, communications module 130 enables wireless transmission of a signal using a protocol consistent with the Zigbee® standard. In another embodiment, communications module 130 enables wireless transmission of a signal using an infrared frequency. In another embodiment, communications module 130 enables wireless transmission of a signal using a GPRS frequency.

Device 100 may also include one or more of the following components: input device 140, memory 150, processor 160, display 170, and tape locking mechanism (not shown). These components may be operatively coupled and communicate via a bus or other suitable communication medium. Input device 140 may be a button, keypad, touch-sensitive screen, or suitable input control. Input device 140 is used, in some embodiments of the inventions, to initiate a sensor reading, a wireless transmission, and/or storage of a sensor reading or a variable derived from a sensor reading in memory 150. In some embodiments of the invention, device 100 features a plurality of input devices 140, each of which may perform one or more of the foregoing functions.

Processor 160 may include a computer chip, a digital signal processor board, an analog computer, a specially constructed computing platform for implementing the features and operations disclosed herein, and/or any other suitable information-processing device. In one illustrative embodiment, processor 160 converts a sensor reading to a variable corresponding to a measurement. In the illustrative embodiment, processor 160 is operatively coupled to sensor 120 and communications module 130. Processor 160 can also be coupled to memory 150 and communications module 130.

Memory 150 may include on-board memory, cache memory, random access memory, flash memory, virtual memory, or any other device for storing data. Memory 150 may be used to store one or more sensor readings or variables derived from a sensor reading. More than one sensor reading or variable may be collected in memory 150 and later collectively transmitted by communications module 130 as a wireless signal.

Display 170 may be a liquid crystal screen or other suitable electronic display. Display 170 may be used, for example, to display one or more current measurements and/or measurements in memory.

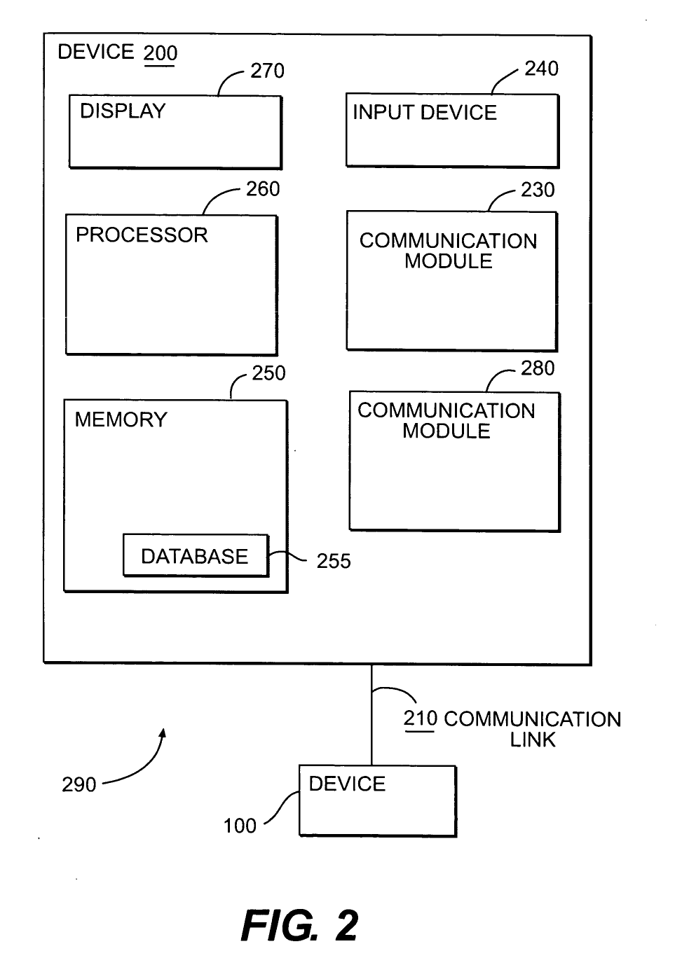

FIG. 2 is a block diagram of a portable data collection device, consistent with the present invention. System 290 may implement one or more methods consistent with features and principles of the present invention. System 290 includes device 100 of FIG. 1, device 200, and communication link 210.

Device 200 includes a communications module 230 and a memory 250. The components of device 200 can be integrated within a housing (not shown). Communications module 230 of device 200 includes components that enable receipt of a wireless signal from communications module 130, thereby creating communication link 210 with device 100. Accordingly, communications module 230 should be selected to work with the same frequency range and protocol as communications module 130 of device 100. Memory 250 of device 200 is capable of storing a measurement derived from the wireless signal received by communications module 230.

Memory 250 can include on-board memory, cache memory, random access memory, flash memory, virtual memory, or any other device for storing data. Memory 250 can include a database 255. Database 255 associates a set of information relating to an object, such as a package or freight. Such information can include, for example, an identifier, an origination address, a destination address, billing information, relevant phone numbers, and one or more measurements of the object. The identifier, for example, can be a tracking number. For each object represented in database 255, database 255 can be used to associate the relevant information. Collection and association of information relating to an object can be the primary function of device 200.

In some embodiments of the invention, device 200 may include one or more of the following components: input device 240, processor 260, display 270, and communications module 280. Communications module 280 enables device 200 to transmit information from memory 250 using a different frequency range and/or protocol than communications module 230. In some embodiments, communications module 280 enables transmission of a long-range wireless signal whereas communications module 230 enables receipt of a short-range wireless signal. In one embodiment, communications module 280 enables transmission of a wireless signal using an available frequency and long-range transmission protocol. For example, communications module 280 can enable transmission of a wireless signal using a protocol consistent with the Wi-Fi, GSM, GPRS, Edge, or UTMS standard. Communications module 280 may be incorporated in a communication system in a courier's vehicle and transmit data from device 200 when placed in a cradle in the courier's vehicle.

Input device 240 may be a button, a keypad, a touch-sensitive screen, or other suitable input control. Input device 240 may be used, for example, to initiate transmission of a wireless signal corresponding to information from memory 250. Input device 240 may be used, for another example, to initiate display of information from memory 250. In some embodiments of the invention, device 100 features a plurality of input devices 140. Device 200 may also include an electronic reading instrument, such as a bar code reader/scanner, to read information on a label, package, or freight for storage and association with other variables in device 200. Device 200 can be a hand held device, such as manufactured by Intermec and Motorola, configured and/or programmed to operate according to the principles of the present invention.

Processor 260 may include a computer chip, a digital signal processor board, an analog computer, a specially constructed computing platform for implementing the features and operations disclosed herein, and/or any other suitable information-processing device. In one embodiment, processor 160 generates a display signal, which prompts a user to collect different types of information about an object such as a package or freight. Processor 260 converts a wireless signal received by communications module 230 to a measurement of a dimension of the object. Processor 260 is operatively coupled to memory 250 and communications module 230.

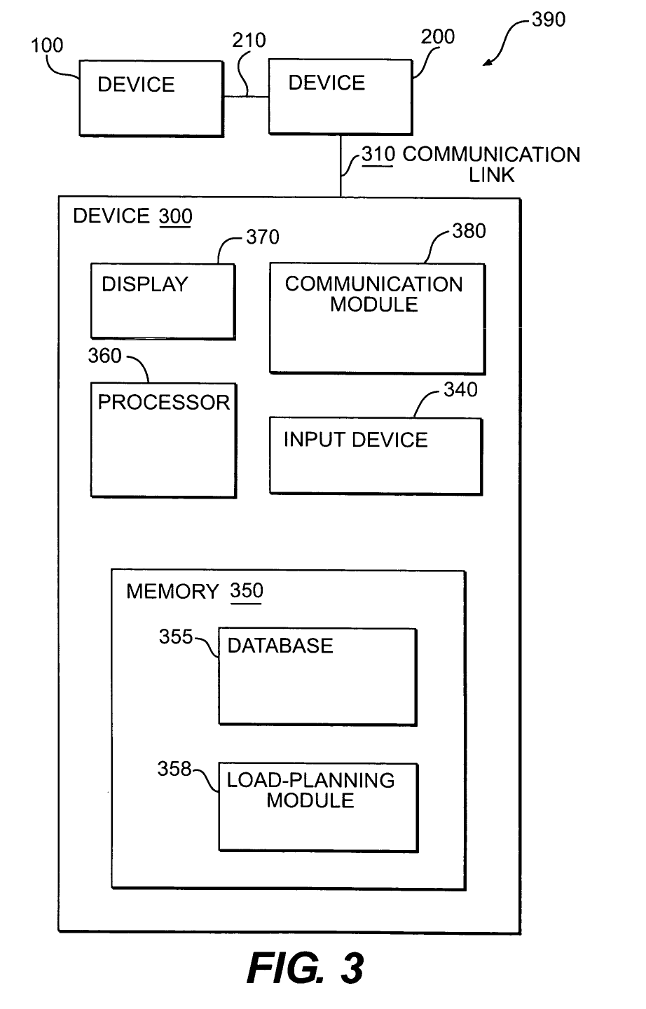

FIG. 3 is a block diagram of a system for generating a loading plan based on a dimension of an object, in accordance with another illustrative embodiment. System 390 may implement one or more methods consistent with features and principles of the present invention. System 390 includes device 100, device 200, device 300, and communication links 210 and 310.

Device 300 includes a communications module 380 and a memory 350. Communications module 380 of device 300 includes components that enable receipt of a wireless signal from communications module 230, thereby creating communication link 310 with device 200. Accordingly, communications module 380 should be selected to work with the same frequency range and protocol as communications module 280 of device 200.

Memory 350 may include on-board memory, cache memory, random access memory, flash memory, virtual memory, or any other device for storing data. Memory 350 of device 300 includes load-planning module 358. Load-planning module 358, in some embodiments, can generate a plan for shipping a plurality of objects from a hub to their various destinations, possibly through intermediate hubs. Load-planning module 358 can be, for example, ACCOPS. Load-planning module 358, in some embodiments, can adjust a driver's remaining pick-up schedule based on available object dimensions.

Memory 350 is capable of storing information derived from the wireless signal received by communications module 280. Memory 350 may include a database 355. Database 355 includes information for generating a loading plan for one or more transport vehicles using the load-planning module. This information may include, for each of a plurality of objects, an identifier, a destination, and one or more measurements of the object. Database 355 may also include additional information for each of the plurality of objects, such as tracking and billing information.

In some embodiments of the invention, device 300 may include one or more of the following components: input device 340, processor 360, and display 370. Processor 360 may include a mainframe, a laptop, a personal computer, a workstation, a computer chip, a digital signal processor board, an analog computer, and/or any other information-processing device or combination of devices. Further, processor 360 may be implemented by a general-purpose computer or data processor selectively activated or reconfigured by a stored computer program, or may be a specially constructed computing platform for implementing the features and operations disclosed herein. These components of device 300 may be operatively coupled and communicate via a bus or other suitable communication medium.

Processor 360, in some embodiments of the invention, is coupled to memory 350 and display 370. Processor 360 may use load-planning module 358 and database 355 from memory 350 to generate a loading plan for one or more transport vehicles. Processor 360 may convert a wireless signal received by communications module 380 to a variable associated with a dimension of the object.

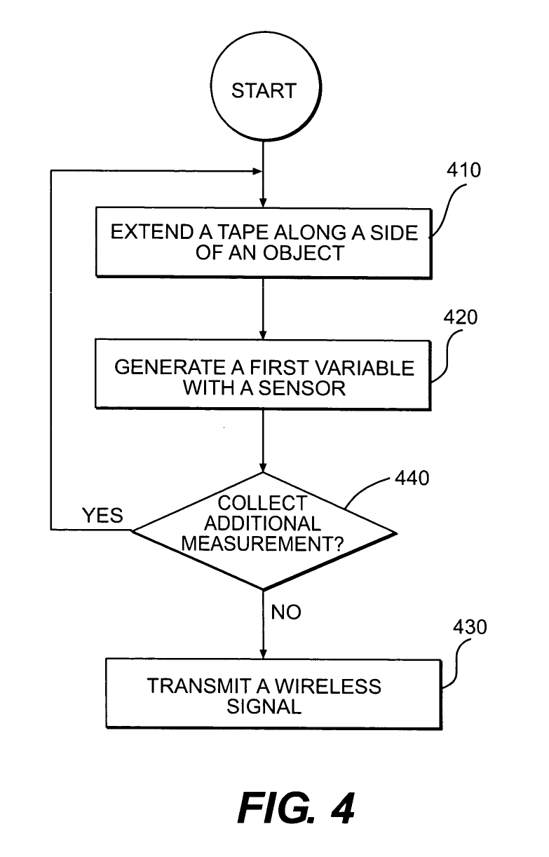

FIG. 4 is a flow chart of an exemplary method for measuring a dimension of an object. The method of FIG. 4 may be implemented by device 100, for example, when a user wants to measure an object. In stage 410, a tape is extended along a first side of the object to obtain a measurement of the object. In stage 420, a sensor reading corresponding to the measurement, is generated with a sensor while the tape is extended along the first side of the object. In stage 430, a wireless signal, corresponding to the measurement, is transmitted using a wireless transmission protocol. The signal may be received by device 200 or another station where the received measurement may be acted upon. In one embodiment of this method, the transmission can be initiated by a user in stage 440, for example, by activating a selection mechanism on a touch sensitive screen or other input mechanism.

In another exemplary method for measuring a dimension of an object, a variable, such as centimeters of tape extension or wheel revolutions, for example, associated with the measurement is identified before a wireless signal is transmitted in stage 430. In stage 430, a wireless signal, including the variable in a format consistent with wireless transmission protocol, is transmitted.

In another exemplary method for measuring a dimension of an object, a second dimension of the object is measured before a wireless signal is transmitted in stage 430. In such a method, the first measurement is stored in response to stage 440 and stages 410 and 420 are repeated and a second sensor reading, corresponding to a second measurement, is generated with the sensor when the tape is extended along a second side of the object. In stage 430, a wireless signal, corresponding to the first and second measurements, is transmitted using a wireless transmission protocol to, for example, device 200 or other station where the received measurements may be acted upon. In one embodiment of this method, the transmission is initiated by a user.

In another exemplary method for measuring a dimension of an object, a third dimension of the object is measured before a wireless signal is transmitted in stage 430. In such a method, the first measurement is stored in response to stage 440 and stages 410 and 420 are first repeated. The second measurement is stored in response to stage 440 and stages 410 and 420 are repeated again. A third sensor reading, corresponding to the third measurement, is generated with the sensor after the tape is extended along a third side of the object. In stage 430, a wireless signal, corresponding to the first, second, and third measurements, is transmitted using a wireless transmission protocol to, for example, device 200 or other station where the received measurements may be acted upon.

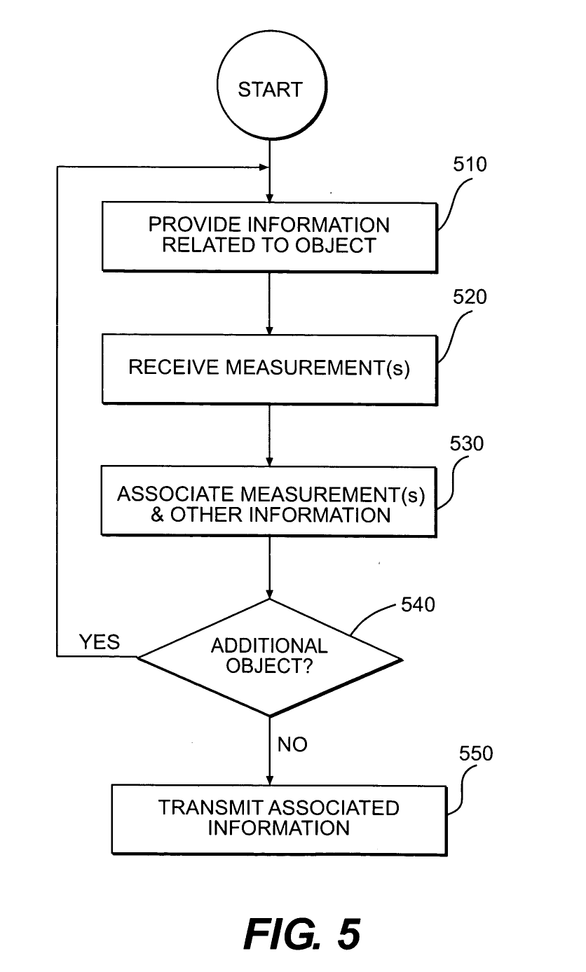

FIG. 5 is a flow chart of an exemplary method for wirelessly receiving and associating information relating to an object, consistent with the present invention. The method of FIG. 5 may be implemented, for example, by device 200. In stage 510 of FIG. 5, information related to an object is provided. When a courier picks up a package for shipment, for example, the courier may input an object identifier into device 200. The identifier may be a package tracking number input via a keypad or a scanner. Additional information such as an origination address, a destination address, billing information, and/or relevant phone numbers may additionally or alternatively be provided.

In stage 520 of FIG. 5, a measurement is received via a wireless signal. The entry of information related to an object may cause device 200 to prepare for receiving the wireless signal. Additionally or alternatively, the courier may select a pull down menu on the device 200 to prepare device 200 to receive the wireless signal. Device 200 then enters a state operative to receive a measurement. For example, device 200 can prepare fields, within a data record, for receiving the measurements of a package for association with package tracking number and other information related to the package. In one embodiment, three fields are prepared for receiving length, height, and width measurements. In stage 530 of FIG. 5, a measurement is associated with other information related to the object. The order of stages 520 and 530 may be reversed.

In stage 540 of FIG. 5, device 200 checks if information is to be provided for a second object. If so, device 200 prepares to receive information related to a second object. If not, device 200 prepares to transmit a wireless signal corresponding to the associated information. In stage 550 of FIG. 5, the associated information is transmitted via a wireless signal.

The method of FIG. 5 may be used in conjunction with the method of FIG. 4. In such a combination, a courier can measure a dimension of a package with device 100. The courier can use communication module 130 of device 100 to transmit the measurement to device 200 wirelessly as discussed in association with FIG. 4. Communication module 230 of device 200 detects and receives the wireless signal from device 100. Device 200 can then automatically populate one or more fields for storing one or more measurements in association with other package information. Device 200 may respectively populate the three fields in order of receipt of the measurements from the device 100. Alternatively, a courier may select a specific field of device 200 for receiving a specific measurement, in which case device 200 uses the measurement received from device to populate the selected field. Specific designation of fields to be populated in the device 200 may be chosen as desired.

Once the measurement or measurements are stored in associated with the other information related to the package, the courier is ready to transmit the associated information to another unit, such as device 300. The courier can initiate transmission of the package information to, for example, device 300. The associated information can be transmitted to device 300 via a long-range communication protocol. Device 300 may be part of a freight hub. Device 300 can use package information, such as the measurements, to develop a loading plan or generate billing or cost information prior to arrival of the packages or freight at the hub. This transmission from device 200 may be initiated when the device 200 is placed in a cradle of the courier's vehicle. In this case, communication module 280 of device 200 is located in the courier's vehicle. Alternatively, the communication module 280 of device 200 can be incorporated into the housing of the device 200.

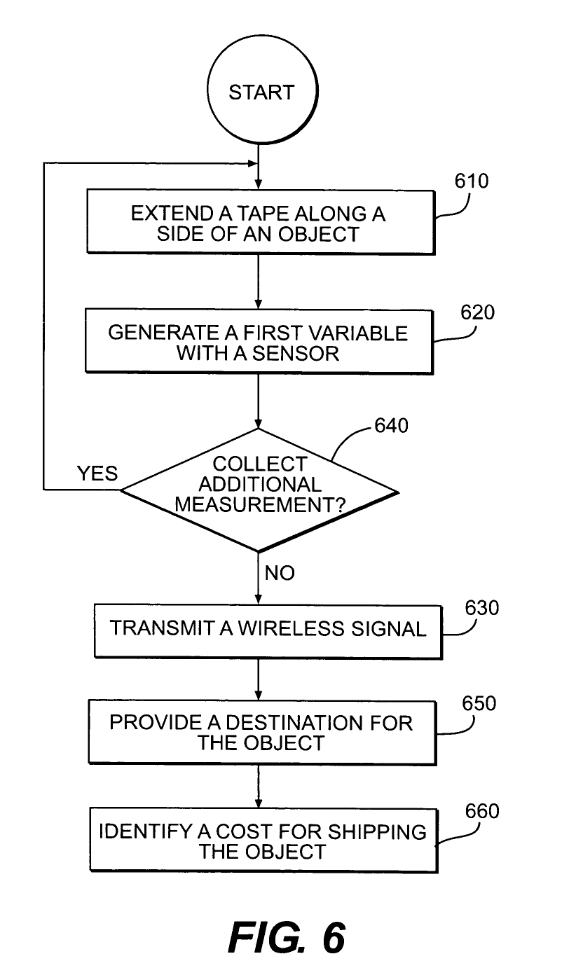

FIG. 6 is a flow chart of an exemplary method for determining a cost of shipping an object to a destination, in accordance with another illustrative embodiment. The method of FIG. 6 may be implemented by system 290, for example, when a user wants to identify the cost of shipping the object to its destination. Stages 610, 620, 630, and 640 of FIG. 6 are similar to stages 410, 420, 430, and 440 of FIG. 4. Variations described with respect to FIG. 4 are similarly applicable to FIG. 6.

After execution of stages 610-640, in stage 650 of FIG. 6, a destination for the object is provided, such as a destination zip code or city name. A user may use any available input device to provide the destination. In stage 660, a cost for shipping the object is identified. The cost may be based on one or more measurements of the object. In one embodiment, at stage 660, a processor looks up a cost associated with an object dimension in memory. In one embodiment of stage 660, a processor determines a cost associated with an object dimension based on space available in a container, trailer, or cargo bay. Additionally or alternatively, a processor determines a cost associated with an object dimension based on a need for an additional container to transport the object.

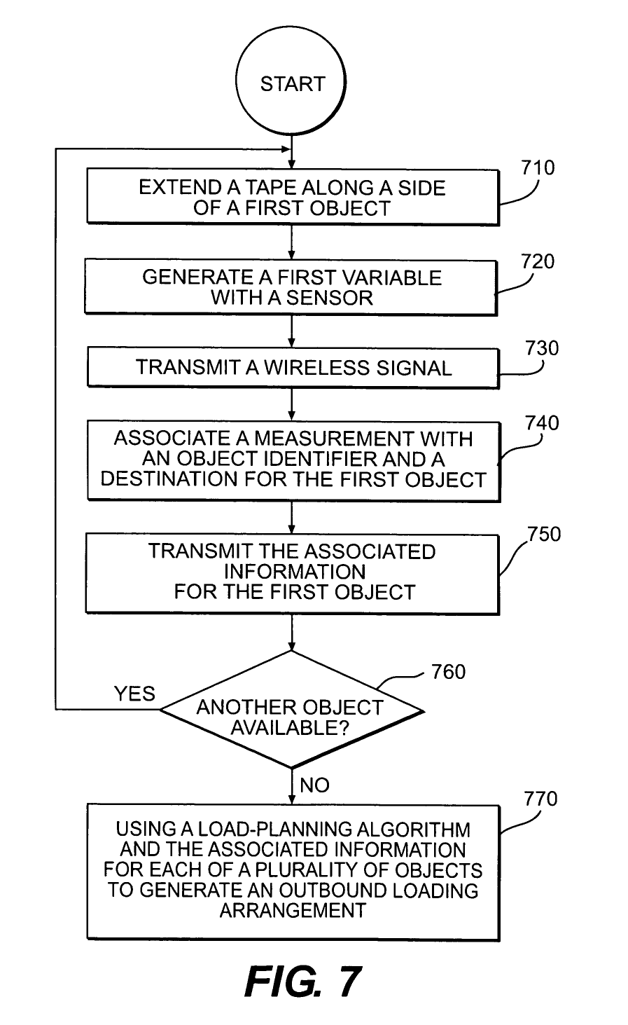

FIG. 7 is a flow chart of an exemplary method for generating a loading plan for a plurality of objects, in accordance with another illustrative embodiment. The method of FIG. 7 may be implemented by system 390, for example, when a user wants to generate a loading plan for a plurality of objects going to a destination. Stages 710, 720, and 730 of FIG. 7 are similar to stages 410, 420, and 430 of FIG. 4. Variations described with respect to FIG. 4 are similarly applicable to FIG. 7.

After execution of stages 710-730, in stage 740 of FIG. 7, information is associated with an object. The information includes, for example, an identifier, a destination, and a variable. The variable, in some embodiments, is derived from a wireless signal. The variable corresponds to a measurement of the object. The information may include a plurality of variables, each of which corresponds to a different measurement of the object.

In stage 750 of FIG. 7, information associated with the object is transmitted using a long-range transmission protocol. Where device 200 is used to implement the method of FIG. 7, input device 240 may be used to initiate transmission of the information. Additionally or alternatively, a timer in processor 260 may periodically trigger transmission of information. Additionally or alternatively, a transmission may be triggered by processor 260 whenever a new set of information is available for an object.

In stage 760 of FIG. 7, the generation of a loading plan is triggered. Where device 300 is used to implement the method of FIG. 7, input device 340 may be used to trigger the generation of a loading plan. Additionally or alternatively, a timer in processor 360 may periodically trigger the generation of a loading plan. Additionally or alternatively, processor 360 may periodically trigger the generation of a loading plan whenever a new set of information is available for an object.

In stage 770 of FIG. 7, a load-planning algorithm and information associated with a plurality of objects are used to generate a loading plan. The loading plan may apply, for example, to one or more transport vehicles going to a destination. The loading plan may be used, for example, to determine the number of transport vehicles needed for the destination. Loading plans may be generated more than once over the course of a shift before the plurality of objects heading for a destination are received at a hub. The final loading plan can be used in conjunction with object identifiers to create an efficient loading arrangement with one or more transport vehicles.

The embodiments and aspects of the invention set forth above are only exemplary and explanatory. They are not restrictive of the invention as claimed. Other embodiments consistent with features and principles are included in the scope of the present invention.

In the foregoing description, various features are grouped together for purposes of streamlining the disclosure. This method of disclosure is not to be interpreted as reflecting an intention that the claimed invention requires more features than are expressly recited in each claim. Rather, as the following claims reflect, inventive aspects may lie in fewer than all features of a single foregoing disclosed embodiment. Thus, the following claims are hereby incorporated into this description, with each claim standing on its own as a separate embodiment of the invention.

What is claimed is:

1. A portable device for collecting a measurement of an object and transmitting the measurement and other information related to the object comprising:
a first communication module for receiving a first wireless signal that corresponds to a measurement of a dimension of the object;
a memory for storing the measurement derived from the first wireless signal in association with an object identifier; and
a second communication module for transmitting a second wireless signal that corresponds to the measurement of the object and the objection identifier.

2. The device of claim 1 wherein the first communication module enables wireless communication with a short-range wireless transmission protocol.

3. The device of claim 1 wherein the second communication module enables wireless communication with a long-range wireless transmission protocol.

4. The device of claim 1 wherein the first wireless signal corresponds to a plurality of measurements of dimensions of the object and wherein the memory stores the plurality of measurements derived from the first wireless signal in association with the object identifier.

5. The device of claim 1 wherein the first communication module receives a plurality of first wireless signals, each corresponding to a measurement of a different dimension of the object, and wherein the memory stores a plurality of measurements, each derived from one of the plurality of first wireless signals, in association with the object identifier.

6. The device of claim 1 wherein the memory further stores a destination for the object in association with the object identifier.

7. A system for measuring a dimension of an object comprising:
a tape measure comprising a communication module for transmitting a wireless signal that corresponds to a measurement of a dimension of the object; and
a portable data collection device comprising a communication module for receiving the wireless signal and a memory for storing the measurement derived from the wireless signal.

8. The system of claim 7 wherein the communication module of the portable data collection device is configured to receive wireless communication with a short-range wireless transmission protocol.

9. The system of claim 7 wherein the memory associates the measurement with other information about the object.

10. The system of claim 9 wherein the portable data collection device further comprises a second communication module, which enables transmission of the measurement and other information about the object to a central processor with a long-range transmission protocol.

11. The system of claim 10 wherein the measurement and other information about the object includes a measurement of length, a measurement of width, and a measurement of height of the object.

12. The system of claim 11 wherein the other information about the object includes a destination.

13. The system of claim 12 further comprising a central processor comprising:
a communication module, which enables receipt of the measurement and other information about the object with a long-range transmission protocol; and
a memory comprising an outbound load-planning module;
wherein the central processor generates an outbound loading plan for one or more transport vehicles using the measurement and the outbound load-planning module.

14. A method for collecting a dimension of an object comprising:
extending a tape along a first side of a first object;
generating a first variable, corresponding to a first measurement of the first side of the first object, with a sensor while the tape is extended along the first side of the first object;
transmitting a first wireless signal, which corresponds to the first variable, using a short-range wireless transmission protocol;
associating the first measurement, derived from the first wireless signal, with an object identifier and a destination for the first object; and
transmitting a second wireless signal, which corresponds to the associated first measurement, identifier, and destination of the first object, using a long-range transmission protocol.

15. The method of claim 14 further comprising
extending the tape along a second side of the first object;
generating a second variable, corresponding to a second measurement of the second side of the first object, with the sensor while the tape is extended along the second side of the first object; and
associating the second measurement with the object identifier and the destination of the first object.

16. The method of claim 14 further comprising
extending the tape along a first side of a second object;
generating a second variable, corresponding to a second measurement of the first side of the second object, with the sensor while the tape is extended along the first side of the second object;
transmitting a third wireless signal, which corresponds to the second variable, using the short-range wireless transmission protocol; and
associating the second measurement, derived from the third wireless signal, with an object identifier and a destination of the second object.

17. A method for planning a loading arrangement based on measurements and destinations of a plurality of objects:
extending a tape along a first side of a first object;
generating a first variable, corresponding to a first measurement of the first side of the first object, with a sensor while the tape is extended along the first side of the first object;
transmitting a first wireless signal, which corresponds to the first variable, using a wireless transmission protocol;
associating the first measurement, derived from the first wireless signal, with an object identifier and a destination of the first object;
transmitting a second wireless signal, which corresponds to the associated first measurement, identifier, and destination of the first object, using a long-range transmission protocol;
repeating the foregoing for a second object; and
using a load-planning algorithm and the associated first measurement, identifier, and destination of each of the plurality of objects to generate an outbound loading plan for an outbound vehicle.

18. The method of claim 17 further comprising, after transmitting the second wireless signal, bringing the first object to a shipping hub.

19. The method of claim 17 further comprising, after using the load-planning algorithm and the associated first measurement, identifier, and destination for the plurality of objects to generate the outbound loading plan for the outbound vehicle, bringing the first object to a shipping hub.

20. The method of claim 17 further comprising using the outbound loading plan to determine a number of outbound vehicles required for a destination.

21. A method for collecting a dimension of an object comprising:
rolling a wheel along a first side of a first object;
generating a first variable, corresponding to a first measurement of the first side of the first object, with a sensor based on the revolutions of the wheel;
transmitting a first wireless signal, which corresponds to the first variable, using a short-range wireless transmission protocol;
associating the first measurement, derived from the first wireless signal, with an object identifier and a destination of the first object; and
transmitting a second wireless signal, which corresponds to the associated first measurement, identifier, and destination of the first object, using a long-range transmission protocol.

22. The method of claim 21 further comprising
rolling a wheel along a second side of the first object;
generating a second variable, corresponding to a second measurement of the second side of the first object, with the sensor based on the revolutions of the wheel; and
associating the second measurement with the first measurement, the object identifier, and the destination of the first object.

23. The method of claim 21 further comprising
rolling a wheel along a first side of a second object;
generating a second variable, corresponding to a second measurement of the first side of the second object, with the sensor based on the revolutions of the wheel;
transmitting a third wireless signal, which corresponds to the second measurement, using the short-range wireless transmission protocol; and
associating the second measurement, derived from the third wireless signal, with an object identifier and a destination of the second object.
